(19) United States
(12) Patent Application Publication
(10) Pub. No.: US 2003/0225611 A1
(43) Pub. Date: Dec. 4, 2003

(54) Electronic source inspection process

(76) Inventors: Ethel M. Wilson, Escondido, CA (US); Edward A. Radford JR., Alpine, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 10/160,928

(22) Filed: May 30, 2002

(51) Int. Cl. G06F 17/60

(52) U.S. Cl. 705/11

(57) ABSTRACT

A method for verifying the quality of manufactured components by conducting manufacturing site inspections of components remotely from another site, such as a component integration site. Selected components are physically tested and digitally photographed at the manufacturing site and the resulting test reports and digital photographs are electronically transmitted to the other site. An inspector views the test reports and digital photographs, then generates an inspection report for transmission back to the manufacturing site. Upon receipt of approval of the tested and photographed components, personnel at the manufacturing site ship the components. Component inspectors are relieved of the burden of traveling to manufacturing sites and manufacturers do not have to delay shipment or further production while waiting for a physical inspection of components.

### BACKGROUND OF THE INVENTION

1. Field of the Invention

This invention relates generally to techniques for inspecting manufactured components at the point of source of the components. Complex manufactured apparatus and systems typically include components made by multiple manufacturers, often in different geographical locations. It is highly desirable, and in many cases mandated by contract or government regulation, that manufactured components be inspected at their source of manufacture or assembly, to ensure compliance with technical and quality specifications.

2. Prior Art

In the past, source inspection of components has required the physical presence of a qualified inspector, who performs inspections using appropriate precision equipment at the manufacturing site. In many cases, the inspector uses an optical microscope to examine each manufactured component, or a selected percentage of manufactured components of the same type. The inspector is usually an employee or agent of a contractor responsible for integration and testing of the apparatus or system in which the manufactured components are to be installed. Inspection at the manufacturing site is required to ensure that manufacturing and quality standards have been met before incurring the cost and time delay associated with shipment, and possible return shipment to correct defects. Further levels of inspection are usually needed at the contractor's site. Components may be inspected upon receipt from the manufacturers, who are usually subcontractors of the contractor responsible for the entire system, to ensure that there has been no damage in transit. Additional testing is also performed at the system level as the components are integrated into a system or subsystem.

Travel by inspectors to each manufacturer's site increases the contractor's costs in several respects. First, travel expenditures of each inspector are a significant part of the component manufacturing costs. An indirect cost is additionally incurred whenever an inspector is absent from the contractor's site and is, therefore, unavailable for inspection of components upon receipt or during the integration process. There are significant advantages in having the same inspector perform both source inspection and inspection upon receipt and integration. However, this is often difficult or impossible to achieve if the examiner must make source inspections at one or more widely separated manufacturing sites. Another indirect cost of source inspections as performed prior to the present invention, is that subcontractor work, and shipment of the completed components, must often be suspended while awaiting arrival of the inspector.

Ideally, it would be highly desirable to provide a source testing technique that minimized or eliminated travel costs, and permitted the same inspector to perform both source inspections and inspections at the point of receipt and integration of the components. The present invention is directed to this end.

### BRIEF SUMMARY OF THE INVENTION

The present invention is embodied in a process or method for performing source inspections of manufactured components remotely, without inspector travel to the manufacturing site. Briefly, and in general terms, the method of the invention comprises the steps of electronically receiving from the manufacturing site a test report pertaining to physical tests performed on a selected component produced at the manufacturing site; electronically receiving from the manufacturing site one or more digital photographs recorded at the manufacturing site; associating the test report with the one or more digital photographs; inspecting the one or more digital photographs to determine whether the component meets prescribed specifications; generating an inspection report based on the results of the inspecting step; and transmitting the inspection report to the component manufacturer.

In one embodiment of the invention, the step of electronically receiving the test report includes receiving a facsimile transmission of the test report. The step of electronically receiving one or more digital photographs includes receiving the photographs through a computer communication network.

More specifically, the method further comprises storing the received test report in a shared database; and storing the received one or more digital photographs in the same shared database. The inspecting step includes retrieving the test report and the one or more digital photographs from the shared database, viewing images of the test report and the one or more digital photographs, and determining whether the component meets the prescribed specifications. The method may further comprise receiving components shipped from the manufacturing site; testing and inspecting the received components; generating test and inspection reports pertaining to the received components; storing in the shared database the test and inspection reports pertaining to the received components; and comparing the test and inspection reports transmitted from the manufacturing site with the test and inspection reports generated on receipt of the components.

It will be appreciated from this brief summary that the invention provides a significant advance in the field of on-site inspection of manufactured components. In particular, verification of the quality of manufactured components can be effected without requiring inspectors to travel to distant manufacturing sites to perform inspections. This not only results in a saving in travel costs, but also frees the inspector's time for related tasks, such as physical inspection and testing of components received from the manufacturing site. Other aspects and advantages of the invention will become apparent from the following more detailed description of the invention, taken in conjunction with the accompanying drawings.

### BRIEF DESCRIPTION OF THE DRAWINGS

FIG. 1 is block diagram depicting the principal elements of an inspection process in accordance with the present invention;

FIG. 2 is a flowchart depicting the principal steps performed at a manufacturing site in accordance with the present invention; and

FIG. 3 is a flowchart depicting the principal steps performed at a contractor site in accordance with the present invention.

### DESCRIPTION OF THE PREFERRED EMBODIMENT OF THE INVENTION

As shown in the drawings for purposes of illustration, the present invention pertains to a novel method for performing inspections of manufactured components at their points of manufacture or assembly. In the past, components intended for shipment to another site, usually for integration into a larger structure or system, were inspected at the source site by inspectors who traveled there specifically for the inspections. This procedure not only incurred a significant travel cost, but also occupied the inspectors' time to such an extent that inspections at the point of delivery and integration of the components would be adversely impacted.

In accordance with the present invention, manufactured components are inspected remotely by the inspector, without travel to the manufacturing site. More specifically, and as explained in detail below, digital photographs of the components are recorded at the manufacturing site and then transmitted electronically to the inspector's location, which is usually the site of integration and final testing of the components.

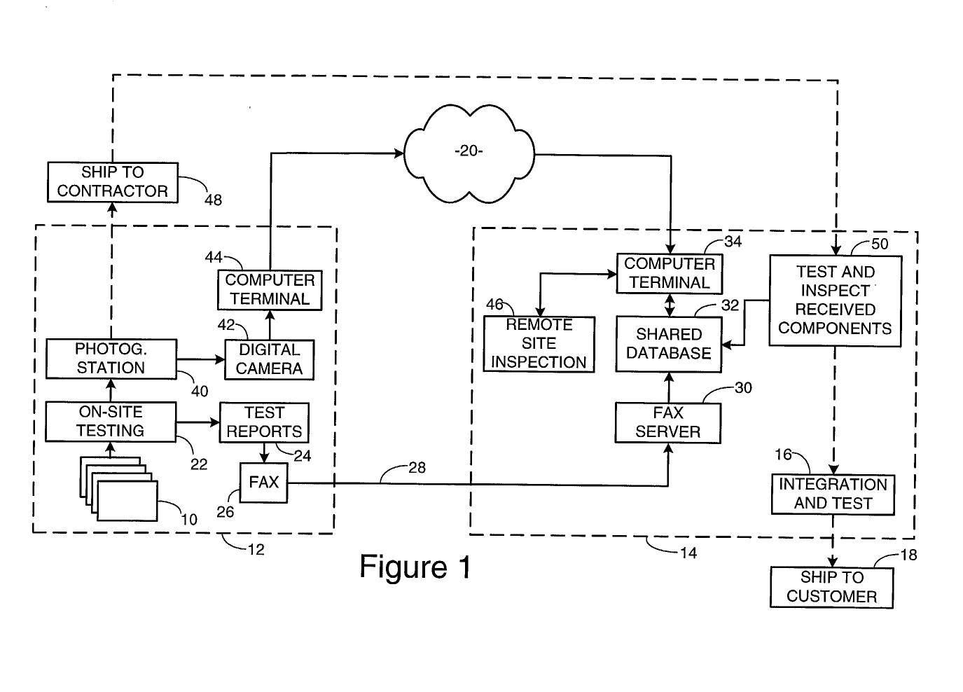

FIG. 1 shows diagrammatically the principal elements of the invention. Manufactured components, indicated by reference numeral 10, are produced at a manufacturing site 12 of a subcontractor, for ultimate shipment to a contractor site 14 for integration and testing, as indicated at 16, and final shipment to a customer or enduser, as indicated at 18. The components 10 may be mechanical parts, electronic components, such as integrated-circuit chip packages, circuit boards, or sub-assemblies of electronic and mechanical components.

The manufacturing site 12 and the contractor site 14 are linked by a computer communication network 20, which may be a private network or intranet, or may be a publicly accessible network, such as the Internet. At the manufacturing site 12, components are tested, as indicated at 22, and test reports 24 are generated. The test reports, in accordance with one embodiment of the invention, are in “hard copy,” i.e., printed form, which are then transmitted to the contractor site 14 by facsimile. Therefore, the manufacturing site 12 may utilize a facsimile (fax) machine 26, from which the test reports 24 are transmitted to the contractor site 14, as indicated by line 28. The reports 24 may be transmitted over a conventional telephone network (not shown) or through the communication network 20. Ideally, facsimile copies of the test reports 24 are received not in a conventional facsimile machine, but in a facsimile server 30 or other computer device at the contractor site 14. Ideally, the fax server 30 stores the reports in a shared database, indicated at 32. An inspector at the contractor site 14 may then view the inspection reports 24 from a computer terminal 34 located at the contractor site 14 and coupled to the shared database 32. It will be understood that the shared database 32 may be resident at the contractor site 14 or at any other convenient location.

At the manufacturing site 12, components 10 that have been tested are digitally photographed at a photography station 40, using a digital camera 42, following specific instructions previously provided to the manufacturer. Two-dimensional images are generated from different viewpoints, depending on the component being inspected. Lighting is arranged to provide an inspector with sufficient information to perform an inspection of the component from the digital images only. The digital images, each containing an identification code that uniquely identifies the component that the image represents, are captured in a computer terminal 44 and then transmitted to the contractor site 14 through the communication network 20. In a simple form of this communication step, the digital photographs may be attached to an electronic mail (email) message from personnel at the manufacturing site 12 to an inspector at the contractor site 14. For convenience, test information received at the contractor site is stored in the shared database 32 under the control of a document sharing and management software package, such as SharePoint Portal Server, supplied by Microsoft Inc.

An inspector at the contractor site performs remote site inspection, as indicated at 46, using the computer terminal 34 to view the test reports 24 and the digital photographs retrieved from the shared database 32, either simultaneously or serially, on a display screen of appropriate resolution. Following prescribed inspection steps, the inspector verifies that the component mentioned in a specific test report and depicted in a corresponding set of digital photographs, meets the requirements established by the contractor, customer, or other end user of the component. Approval or disapproval is recorded in an inspection report associated with the test report and the digital photographs of the tested component. The approval or disapproval is then transmitted back to the manufacturer of the component through the communication network 20.

After completion of remote site testing, approved components 10 are shipped to the contractor site 14, as indicated at 48. On receipt at the contractor site 14, components may be further tested and inspected, as indicated at 50, and the results of this testing and inspection are used to update the shared database 32. The accepted components are then advanced to integration and testing 16 and, finally, are shipped to the customer, as indicated at 18.

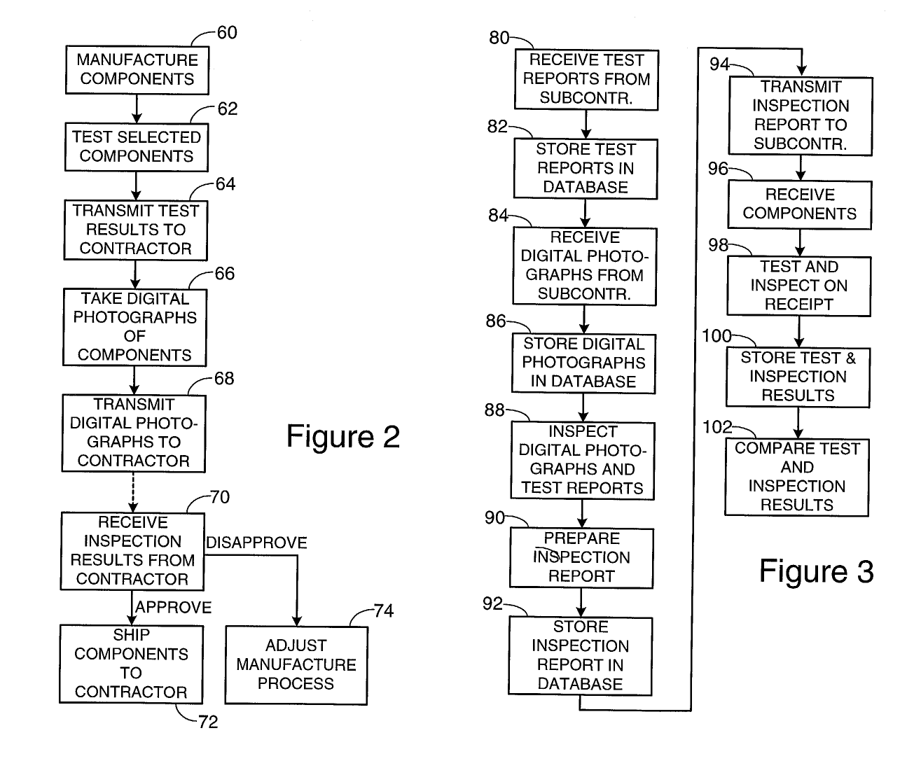

FIG. 2 is a flowchart showing the sequence of steps followed in accordance with the method of the present invention as performed at the manufacturing site 12. Components 10 are manufactured, as indicated in block 60, and then selected manufactured components are tested, as indicated in block 62. In some cases, all manufactured components will be tested. In others, only a selected number of components will be tested. As indicated in block 64, the test results are transmitted to the contractor site 14, using either the facsimile machine 26 or the communication network 20, or by other means. Each tested component is then digitally photographed, as indicated in block 66, and the digital images are transmitted to the contractor site electronically, as indicated in block 68. At this point, the manufacturer's task is complete until receipt of an inspection report from the contractor site 14, as indicated in block 70. If the inspection report contains approval, which may be indicated on a component-by-component basis, the manufacturer ships the component or components, as indicated in block 72. If the inspection report is negative, some type of adjustment is made to the manufacturing process, as indicated in block 74. This may be remanufacture of the components that failed inspection, or may involve a modification to the manufacturing process, depending on information supplied with the negative inspection report.

FIG. 3 is a flowchart of the steps of the method of the invention as performed at the contractor site 14. The contractor receives test reports 24 from the manufacturing site 12, as indicated at 80, and stores them for access by an inspector, as indicated at 82. The contractor also receives digital photographs from the manufacturing site 12, as indicated at 84, and stores them for access by an inspector, as indicated at 86. The inspector then performs a detailed inspection of the digital photographs and the associated test report, as indicated at 88, and prepares an inspection report, as indicated at 90. The inspection report is then stored electronically, as indicated at 92, and simultaneously transmitted to the manufacturer, as indicated at 94.

When components are subsequently received from the manufacturing site 12, as indicated at 96, a selected number of them are tested and physically inspected, as indicated at 98, and the test and inspection results are stored, as indicated at 100. These test and inspection results may be readily compared with the test and inspection results transmitted electronically from the manufacturing site 12, as indicated at 102.

Because the method of the invention avoids the need for on-site inspection at each component manufacturer, quality assurance at the manufacturing site 12 is achieved without the need for inspector travel. Travel costs are greatly reduced or eliminated and the inspector's time is more efficiently utilized performing other related functions, such as testing upon receipt of the components or during integration with other components. Depending on the nature of the components, the process of the invention may be modified to allow components to be shipped directly to a customer integration site different from the contractor site 14. The test data and inspection data may be used as a repository accessible by all concerned parties, including the manufacturer, the contractor and the customer or end-user.

It will be appreciated from the foregoing that the present invention represents a significant advance in site inspection of components destined for integration with other components. In particular, the invention provides a convenient method for inspection of manufactured components without the need for on-site inspection, thereby saving inspector travel costs and freeing inspectors for other related functions. It will also be appreciated that, although a specific embodiment of the invention has been disclosed in detail for purposes of explanation, various modifications may be made without departing from the spirit and scope of the invention. Accordingly, the invention should not be limited except as by the appended claims.

1. A method for remote inspection of components manufactured at a manufacturing site, comprising the steps of:
electronically receiving from the manufacturing site a test report pertaining to physical tests performed on a selected component produced at the manufacturing site;
electronically receiving from the manufacturing site one or more digital photographs recorded at the manufacturing site;
associating the test report with the one or more digital photographs;
inspecting the one or more digital photographs to determine whether the component meets prescribed specifications;
generating an inspection report based on the results of the inspecting step; and
transmitting the inspection report to the component manufacturer.

2. A method as defined in claim 1, wherein the step of electronically receiving the test report includes receiving a facsimile transmission of the test report.

3. A method as defined in claim 1, wherein the step of electronically receiving one or more digital photographs includes receiving the photographs through a computer communication network.

4. A method as defined in claim 1, and further comprising:
storing the received test report in a shared database; and
storing the received one or more digital photographs in the shared database;
and wherein the inspecting step includes retrieving the test report and the one or more digital photographs from the shared database, viewing images of the test report and the one or more digital photographs, and determining whether the component meets the prescribed specifications.

5. A method as defined in claim 4, and further comprising:
receiving components shipped from the manufacturing site;
testing and inspecting the received components;
generating test and inspection reports pertaining to the received components;
storing in the shared database the test and inspection reports pertaining to the received components; and
comparing the test and inspection reports transmitted from the manufacturing site with the test and inspection reports generated on receipt of the components.

6. A method for remote inspection of components manufactured at a manufacturing site, comprising the steps of:
performing physical tests on a selected component produced at the manufacturing site;
electronically transmitting from the manufacturing site a test report pertaining to the physical tests performed;
receiving the test report at a component integration site;
digitally photographing the selected component at the manufacturing site;
electronically transmitting one or more digital photographs of the component from the manufacturing site;
receiving the one or more digital photographs at the component integration site;
associating the received test report with the received one or more digital photographs;
inspecting the one or more digital photographs at the component integration site to determine whether the component meets prescribed specifications;
generating an inspection report based on the results of the inspecting step; and
transmitting the inspection report to the component manufacturer.

7. A method as defined in claim 6, wherein the steps of electronically transmitting and receiving the test report include transmitting and receiving a facsimile copy of the test report.

8. A method as defined in claim 6, wherein the steps of electronically transmitting and receiving the one or more digital photographs include transmission through a computer communication network.

9. A method as defined in claim 6, and further comprising:
storing the received test report in a shared database; and
storing the received one or more digital photographs in the shared database;
and wherein the inspecting step includes retrieving the test report and the one or more digital photographs from the shared database, viewing images of the test report and the one or more digital photographs, and determining whether the component meets the prescribed specifications.

10. A method as defined in claim 9, and further comprising:
receiving components shipped from the manufacturing site;
testing and inspecting the received components;
generating test and inspection reports pertaining to the received components;
storing in the shared database the test and inspection reports pertaining to the received components; and
comparing the test and inspection reports transmitted from the manufacturing site with the test and inspection reports generated on receipt of the components.
